(19) United States
(12) Patent Application Publication
(10) Pub. No.: US 2009/0121479 A1
(43) Pub. Date: May 14, 2009

(54) Device For Use in a Dispensing Apparatus

(76) Inventors: Paul Mallon, Dublin (IE); Terence McSweeney, Long Island City, NY (US)

Correspondence Address: DUANE MORRIS LLP - NY;PATENT DEPARTMENT, 1540 BROADWAY, NEW YORK, NY, 10036-4086, US

(21) Appl. No.: 12/120,062

(22) Filed: May 13, 2008

(30) Foreign Application Priority Data
May 15, 2007 (IE) S2007/0355

(51) Int. Cl. F16L 21/00

(52) U.S. Cl. 285/399

(57) ABSTRACT

The present invention relates to a device, suitable for use with a beverage dispensing apparatus for dispensing a beverage said device comprises a first opening at one end adapted to cooperate with a control flow faucet having a first dimension, and a second opening at the opposite end of the device adapted to cooperate with a shank having a second dimension to provide a flow path for dispensing a beverage from said shank through said control flow faucet. Also presented is a dispensing apparatus comprising the device disclosed herein.

### FIELD OF THE INVENTION

The invention relates to a device for use in a beverage dispensing apparatus. In particular the invention relates to a device for use in dispensing beer or other draught beverages and the like.

### BACKGROUND TO THE INVENTION

Beverage dispensers are well known in the art. One of most common types of beverage dispensers is for dispensing alcoholic drinks, for example beer. Typically a beer dispensing apparatus is designed to dispense beer which is delivered from a beer storage area, for example a keg, to a dispensing point under pressure for dispensing. Dispensing apparatus of this type typically comprises a standard flow control faucet and a valve which is movable from an off position to an on position to allow beer to now through the valve. This type of dispensing apparatus is well known throughout the beverage dispensing industry.

There are various types of known flow control faucets, for example the Universal or SI tap allows a user to adjust the flow rate of the beverage at the: front end of the tap. Another type of tap is the Celli, IMI or the 8K tap, which allows a user to adjust the flow rate of the beverage at the side of the tap by adjusting a lever up or down depending on the rate of speed at which the beverage is being dispensed. A problem in the beverage dispensing industry is that there is no common standard for the flow control faucet. For example, for draught beer dispensers the standard European flow control faucet is not the same as the American or Asian beverage dispensing apparatus as they are of different dimension. This is problematic in the industry as there is no way of installing a standard European flow control faucet to replace a faucet conforming with the American/Asian standard. In practice what is required the entire shank has to be changed to conform with the particular faucet dimension. In some cases this is not possible where the font/tower is factory made or sealed on site resulting in the necessity for a complete replacement of the beverage dispenser.

Another problem occurs with the free flow faucet is the rate of speed or flow rate of the product is determined by the external pressure of gas supplied to the beverage as well as the equilibrium pressure that is around the beverage. If the product requires a high pressure to equilibrate the system and keep associated intrinsic dissolved C0₂ content of the product in solution then the free flow faucet does not allow any restriction of the flow rate. As a result this causes waste beverage to the end user. For example, if the beverage or beer is dispensed into a vessel at a fast rate it will cause a gas break out thus resulting in high or foaming beer causing waste product. If the product flow rate cannot be controlled then the correct equilibrium pressure cannot be applied as the product will pour at a rate which induces foaming. This is highly undesirable when dispensing beverages.

There is therefore a need to provide a device to overcome the above mentioned problems.

### SUMMARY OF THE INVENTION

According to the invention there is provided, as set out in the appended claims, a device, suitable for use with a beverage dispensing apparatus for dispensing a beverage, said device comprises a first opening at one end adapted to cooperate with a control flow faucet having a first dimension, and a second opening at the opposite end of the device adapted to cooperate with a shank having a second dimension to provide a now path for dispensing a beverage from said shank through said control flow faucet.

The advantage of the present invention is that the device serves as an interface or adapter between the control flow faucet and the shank having different dimensions. The design of the device does not allow the break out of gas associated with the beverage, which causes unwanted wastage due to foaming.

Suitably, the device comprises a threaded portion for cooperating with a flange of the control flow faucet.

Suitably, the device comprises a tapered portion tapered towards the opposite end to said second opening to connect with said shank. Preferably, the tapered end connects with said shank to provide a seal to allow a flow path between said control flow faucet and said shank.

It will be appreciated that a flange is provided at the tapered end to cooperate with a thread on the shank to provide a seal. The tapered end allows for the flow path to be reduced gradually without allowing a gas break out in the draught beverage.

In one embodiment, the threaded portion separate to the tapered portion when said device is nut in use. The threaded portion can cooperate with the separate tapered portion in use to provide a flow path for dispensing a draught beverage from said shank through said control flow faucet.

### BRIEF DESCRIPTION OF THE DRAWINGS

The invention will be more clearly understood from the following description of an embodiment thereof, given by way of example only, with reference to the accompanying drawings, in which:

FIG. 1 illustrates the device according to the present invention;

FIG. 2 illustrates a faucet and a shank of a known beverage dispensing apparatus;

FIG. 3 illustrates the device in operation with part of a beverage dispensing apparatus of FIG. 2 according to one aspect of the invention; and

FIG. 4 illustrates a further embodiment of the device according to the present invention.

### DETAILED DESCRIPTION OF THE DRAWINGS

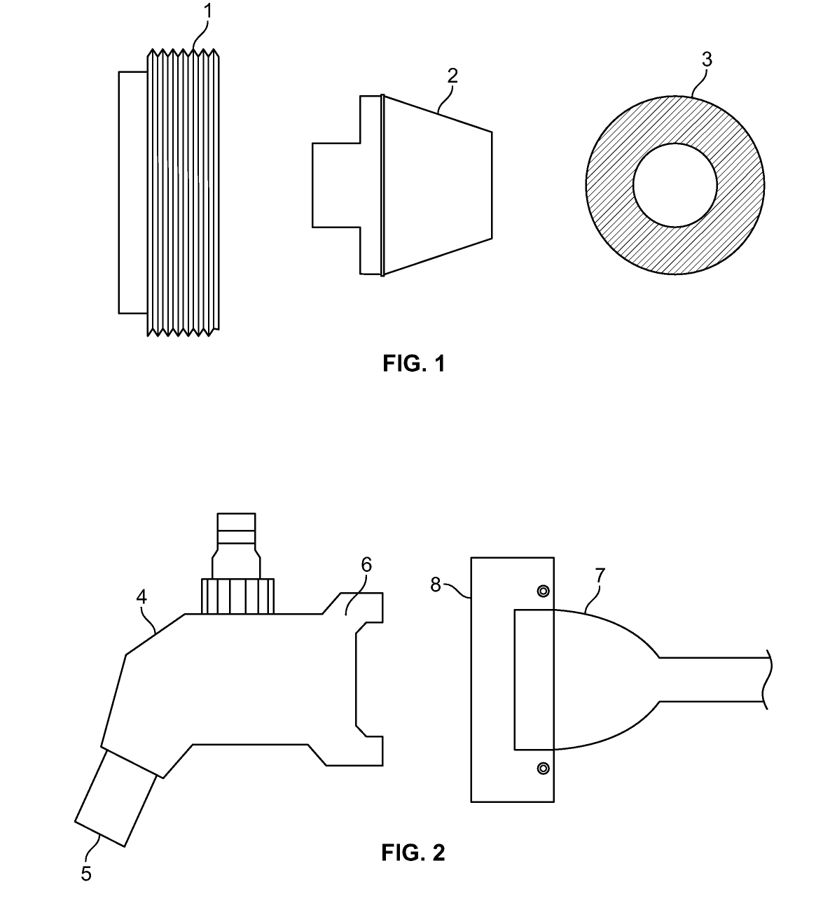

Referring to FIG. 1 there is illustrated the device according to the present invention. The device comprises a threaded section (1) and a tapered section (2). Reference numeral (3) shows a cross sectional view of the tapered portion (2). Referring to FIG. 2 there is illustrated a typical control flow faucet (4) having an outlet (5) for a beverage to be dispensed. Associated with the control flow faucet is a threaded portion (6). A shank (7) is provided with a locking means (8), for example a locking nut. The shank (7) is typically attached via tubing or some conveying means to a beverage storage area, for example a keg (not shown).

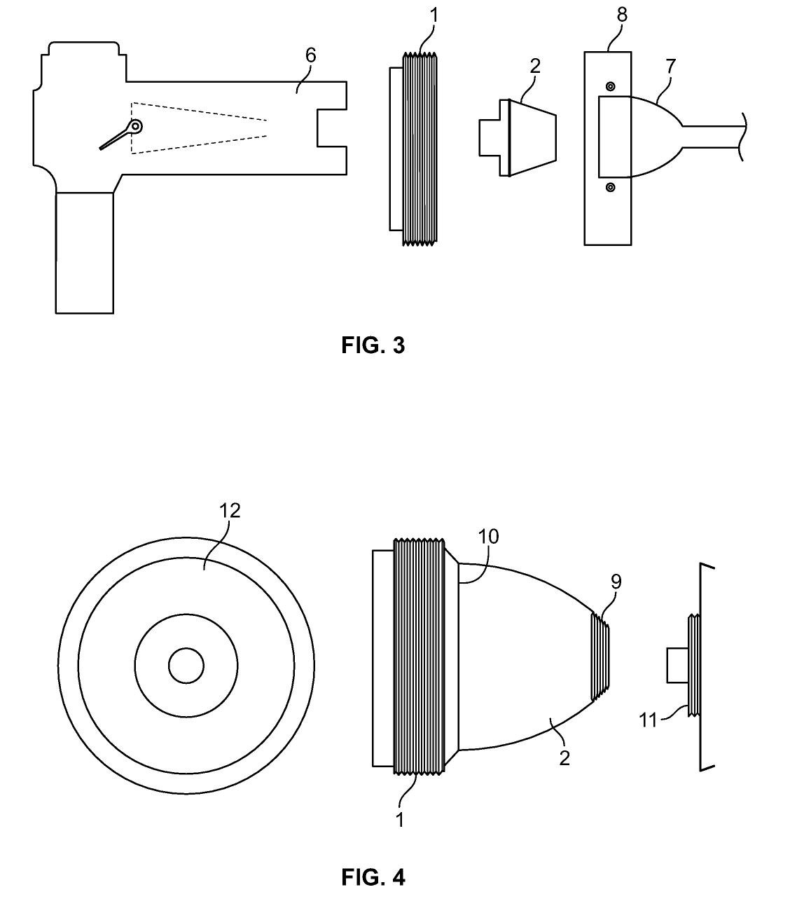

FIG. 3 shows the device of the present invention in operation. The threaded portion (1) of the device is dimensioned to fit to the threaded portion (6) of the tap (4). The threaded portion (1) can be dimensioned to fit the standard flow control faucet either using European or US standard dimensions. Suitably the thread portion (1) cooperates with the threaded portion (6) of the faucet (4) by threading to secure onto a flange. The threaded portions (1) and (6) forms an airtight seal. The tapered portion (2) connects to the threaded portion (I) either using a snap in connection or a further threaded portion to securely attach to the inside surface of the threaded portion (1). Finally, the tapered portion (2) is tapered at one end to connect with the shank (7). A locking means (8), for example a locking nut, is provided to ensure the tapered portion (2) connects with the shank (7) to form an airtight seal.

The device of the present invention allows the standard flow control faucet (4) to be fitted directly to a different dimensioned shank (7). The device is designed to accommodate various standard flow control faucet (4) and other products, which have flow restriction valve to fit other standard dimensioned shanks. It will be appreciated that the device of the present invention can be made from any type of suitable metal or hard plastic material.

It will be appreciated that the purpose of the device is to install with ease and without replacing the standard American/Asian shank to any standard flow control faucet (4) or dispensing tap in Europe. This is especially advantageous for a sealed beverage dispensing unit where access to the shank (7) is not permitted.

The design of the device does not allow the break out of gas which typically causes foaming. Due to the design of the device, the device can be inserted inside the existing standard American/Asian shank (7) and held in place by the existing faucet (4) threaded portion or flange. Thus the device of the present invention serves as an interface between the standard flow control tap and the standard American/Asian shank. The device allows a straight path for the product to the dispense point at outlet (5). In effect the device of the present invention acts as type of flow regulator. Typical dimensions of the control flow faucet and the shank can vary. For example European standard faucets have a ⅜ inch thread such as the Celli, IMI and SK taps, mentioned above. The standard SI tap typically comprises a ½ inch thread. For US and Asian shanks typically have 1 inch or ⅞ inch thread. These dimension can vary and are known in the beverage industry.

It will be appreciated the device of the present invention enables the standard flow control faucet (4) to be inserted into the standard American/Asian shank (7) and connected by the American/Asian threaded portion or flange, hence creating a seal and allowing a beverage to be dispensed without break out in the form of foam. The resulting flow control and reduction in the flow rate allows the pressure of the beverage to be increased to the desired equilibrium pressure for each individual product.

It will be appreciated that the device of the present invention can be dimensioned to operate in reverse to the above and be adapted to fit a European standard shank to an American standard faucet.

The device allows a dispensing beverage apparatus to be balanced with the correct pressure and keep any C0₂ in solution thus avoiding foaming at the faucet and producing associated product waste. Typically the interior of a keg contains beer and C0₂. To maintain this form of carbonation prevents gas out break in the product and prevents dispensing problems. The head space must be filled with gas so that the pressure provided in the head space acts to keep the beers natural carbonation in tact and in balance from the keg to a glass. It will be appreciated that various beers, which are on the market today have more C0₂ content and as a result require a lot more head pressure and thus the flow needs to be slowed down at the dispensing point. The invention achieves thus by the device in combination with a known flow tap so that the pressure is regulated to provide a safe amount of pressure, thus adjusting the flow rate of the tap.

Referring now to FIG. 4 there is illustrated another embodiment of the present invention. In this embodiment the threaded portion (1) and the tapered portion (2) form a single piece and may be integrally formed. The threaded portion is adapted to securely screw onto a thread of the faucet or tap of a first dimension. The tapered portion (2) engages a shank of a second dimension in a similar fashion as set out above. A nylon plastic seal (9) provides a seal inside the shank when in use. A washer (10) increases the strength of the seal and prevents any possible leaks. An additional washer (11) can be provided to seal device to the faucet (6) in use. Reference numeral 12 illustrates a cross sectional view of me device (1, 2). It will be appreciated that the design of the device can be designed to fit any faucet/tap. For example, the CELLI or SK faucets have a wider flange and a shorter neck where a washer is placed over a flow connection and compressed against the have of the tap to from a seal.

It will be appreciated that the device of the present invention can be made from any type of suitable material, for example metal such as copper or other hard plastics type of material.

The words “composes/comprising” and the words “having/including” when used herein with reference to the present invention are used to specify the presence of stated features, integers, steps or components but does not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination. The invention is not limited to the embodiments hereinbefore described but may be varied in both construction and detail.

1. A device, suitable for use with a beverage dispensing apparatus for dispensing a beverage said device comprises a first opening at one end adapted to cooperate with a control flow faucet having a first dimension, and a second opening at the opposite end of the device adapted to cooperate with a shank having a second dimension to provide a flow path for dispensing a beverage from said shank through said control flow faucet.

2. The device as claimed in claim 1, wherein said device comprises a threaded portion for cooperating with a flange of the control flow faucet.

3. The device as claimed in claim 1, wherein said device comprises a tapered portion tapered towards the opposite end to said second opening to connect with said shank.

4. The device as claimed in claim 2, wherein said device comprises a tapered portion tapered towards the opposite end to said second opening to connect with said shank.

5. The device as claimed in claim 4, wherein the tapered end connects with said shank to provide a seal to create the flow path between said control flow faucet and said shank.

6. The device as claimed in claim 5, wherein part of the outer surface of said tapered portion is threaded to cooperate with said shank.

7. The device as claimed in claim 5, wherein the threaded portion is separate to the tapered portion when said device is not in use.

8. The device as claimed in claim 5, wherein said threaded portion cooperates with said tapered portion in use to provide a flow path for dispensing a draught beverage from said shank through said control flow faucet.

9. A beverage dispensing apparatus comprising a device according to claim 1.

10. A beverage dispensing apparatus comprising a device according to claim 5.

11. A beverage dispensing apparatus comprising a device according to claim 8.
